(19) United States
(12) Patent Application Publication
(10) Pub. No.: US 2009/0318393 A1
(43) Pub. Date: Dec. 24, 2009

(54) Film-forming liquid formulations for controlled release of pesticides

(76) Inventor: Shalaby W. Shalaby, Anderson, SC (US)

Correspondence Address: LEIGH P. GREGORY, PO BOX 168, CLEMSON, SC, 29633-0168, US

(21) Appl. No.: 12/456,619

(22) Filed: Jun. 19, 2009

Related U.S. Application Data
(60) Provisional application No. 61/132,816, filed on Jun. 23, 2008.

(51) Int. Cl. A01N 57/00; A01N 47/10; A01N 53/02; A01N 35/00; A01N 31/00

(52) U.S. Cl. 514/124; 514/487; 514/531; 514/675; 514/724

(57) ABSTRACT

A controlled pesticide delivery system includes a film-forming alkanol solution of at least one amphiphilic polymer and at least one pesticide composition for the treatment of at least one pest in gardens, landscapes, forests, and wooden structures, targeting at least one pest selected from fire ants, tent caterpillars, gypsy moths, wood-boring beetles, and bark beetles during at least one phase of their life cycles.

The present application claims the benefit of prior provisional U.S. Ser. No. 61/132,816, filed Jun. 23, 2008.

### FIELD OF THE INVENTION

The present invention is directed to film-forming liquid formulations capable of yielding amphiphilic films for the controlled release of pesticides and other allied agents for treating pests in gardens, landscapes, and forests as well as wooden components of farm, residential, and industrial structures, including fire ants, gypsy moth, tent caterpillar, and different types of wood-boring beetles, and bark beetles at one or more stage or phase of their life cycles. Specifically, the present invention is directed to an alkanol or aqueous alkanol solution of such pesticides and at least one amphiphilic polymer.

### BACKGROUND OF THE INVENTION

Pests in gardens, landscapes, and forests as well as components of different forms of wooden structures can create substantial structural and environmental damages. Among the most common of the damaging pests are fire ants, bark beetles, wood-boring beetles, gypsy moth, and tent caterpillars. Typical members of these groups of pests and traditional methods of treatment are discussed below.

Fire Ants: These are sometimes referred to as simply red ants. They are stinging ants with over 280 species worldwide. They have several common names including Ginger Ants and Tropical Fire Ants (English), aka-kami-ari (Japanese), and Feuerameise (German). Among the methods for controlling fire ants are chemical agents, including water solutions of the pesticides and solid combinations of the pesticides and granulated or pulverized inactive solids. Among the common pesticides for treating fire ants are acephate, carbaryl, chlorpyrifos, bifenthrin, and cypermethrin.

Bark Beetles: These belong to the Scolytidae family and are common pests of conifers and some attack broadleaf trees. Several hundred species occur in the United States. The most common species infesting pines in California are the Western pine beetle (Dendroctonus brevicomis), engraver beetles (Ips spp.), and the red turpentine beetle (Dendrotonus valens). Cedar and cypress bark beetles (Phloeosinus spp.) attack arborvitae, Chamaecyparis, cypress, and redwoods. Oak ambrosia beetles (Monarthrum spp.) and oak bark beetles (Pseudopityophthorus spp.) attach oaks and certain other broadleaves including California buckeye and tanbark oak. The shothole borer (Scolytus rugulosus) attacks damaged trunks of many broadleaved tree species, including English laurel, fruit trees, and hawthorn. The European elm bark beetle (Scolytus multistriatus) feeds only on elms and vectors the Dutch elm disease fungus.

The bark beetles common to landscapes are (1) red turpentine beetles in pines, spruce, and white fur; (2) western pine beetles in coulter and ponderosa pines; (3) engraver beetles in pines; (4) cedar and cypress beetles in arborvitae, cypress, and redwood; (5) oak ambrosia and oak bark beetles in oaks; (6) shothole borer in English laurel, fruit trees, and hawthorn; (7) European elm bark beetles in elms; and (8) southern pine beetles in southern pine. Among the most effective chemical compounds used to control the bark beetles are bifenthrin and carbaryl. Other effective agents are chlorpyrifos, cypermethrin, imidacloprid, and permethrin.

Wood-boring Beetles: After termites, wood-boring beetles are the most important wood-destroying insects in homes. The amount of damage that wood-boring beetles cause depends on many factors. The type of wood (hardwood or softwood), the moisture of the wood, and the environmental conditions at the infestation site all affect the severity of beetle damage. There are four major types of wood-boring beetles, namely, (1) Anobiid beetles—there are more than 20 kinds of these beetles, a few of which infest wood and most infest grain products; (2) Lyctid Powderpost beetles—there are more than 35 kinds in the United States and they infest hardwoods such as oak; (3) Bostrichid Powderpost beetles—these are sometimes referred to as “false” or “large” powderpost beetles, bamboo bores or lead-cable borers and they infest freshly cut hardwood; and (4) old house borer beetles, which belong to a group called Cerambycid beetles—they infest softwoods, especially pine, and can be found in old houses, but more commonly in new homes. Among the commonly used chemical compounds is chlorpyrifos applied as a 0.25 to 0.5 percent solution in water.

Gypsy Moth—In North America the gypsy moth (Lymantria dispar) is known to feed on the foliage of hundreds of species of plants, but its most common hosts are oaks and aspen. Gypsy moth hosts are located throughout most of the contiguous United States but the highest concentrations of host trees are in the southern Appalachian Mountains, the Ozark Mountains, and in the northern Lake States. Gypsy month populations are typically eruptive in North America; in any forest stand densities may fluctuate from near 1 egg mass per hectare to over 1,000 per hectare. When densities reach very high levels, trees may become completely defoliated. Several successive years of defoliation, along with contributions by other biotic and abiotic stress factors, may ultimately result in tree mortality. In most northwestern forests, less than 20 percent of the trees in a forest will die but occasionally tree mortality may be very heavy.

Effective chemical compounds used to control the gypsy moth are acephate, carbaryl, and diflubenzuron.

Tent Caterpillars: In North America there are two types: the forest (Malacosoma disstria) and eastern (Malacosoma americanum) tent caterpillars. The forest tent and eastern caterpillars are similar in habits and appearance. Their favorite hosts are oak, poplar, maple, and birch. The caterpillars do not build nests but leave mats of silken threads on trees where they travel or rest. The eastern tent caterpillar feeds on apple, crabapple, and cherry trees and builds distinctive nests in the forks of trees. The tent caterpillar feeds on the buds and the nests become apparent in late May. As the larvae grow they begin to feed on leaves. When the population increases, it is not uncommon for trees and forests to be defoliated. The caterpillar matures in the first part of June, with adult moths appearing during the last part of the month, when egg laying takes place. There is one generation per year. Forest tent caterpillars have denuded forests in many areas for up to five years in a row. Trees can usually survive such defoliation, but with reduced growth. Management for eastern and forest tent caterpillars is similar, except nests of eastern tent caterpillars can be removed and destroyed. The effective chemical compounds used in the management of tent caterpillars include acephate, methoxychlor, malathion, and carbaryl.

Analysis of the above discussion on the five major pests and their management using chemical agents as pesticides indicates that (1) only about a dozen agents are widely used in the United States in spite of the extensive disclosure in the patent literature of many other agents [U.S. Pat. Nos. 7,361,653; 7,318,930; 7,326,704; 7,241,767; 7,211,270; 7,157,475; 7,148,217; 6,750,256; 6,544,989; 6,391,327; 4,839,383]; (2) about half of the widely used chemical pesticides are effective in controlling more than one type of pest; (3) practically all formulations of the common chemical pesticides of the prior art comprise water solutions, emulsions, foams, or mixtures with solid materials to regulate the release of the active agents [U.S. Pat. Nos. 7,037,494; 6,772,694; 6,755,400; 5,997,945; 5,418,164; 4,170,631]; (4) most of the application methods of pesticide formulations are pest-specific and depend to a great extent on the phase of the pest life cycle; (5) limited attention was directed to water-resistant pesticide compositions [U.S. Pat. No. 5,556,631]; and (6) the effectiveness of commercially available formulations is highly compromised because of either premature loss of the active agent from the application site by being easily washable by water or having limited accessibility to the pest by being part of an improperly designed controlled release system. Obviously, none of the prior art has dealt with the use of a controlled release system that resists environmental compromising factors (such as being washed out by water), easily applied to form an adhering film, and compatible for use with more than one chemical agent to treat more than one pest during at least one phase of its life cycle. And this provided the incentive to pursue the study, subject of the present invention, which provides a novel controlled release system having these unique attributes which have not been disclosed in the prior art.

### SUMMARY OF THE INVENTION

This invention deals, in general, with a film-forming composition for the treatment of pests which include an alkanol or aqueous alkanol solution of at least one amphiphilic polymer and a pesticide wherein upon application the pesticide is released in a controlled manner, wherein the alkanol or aqueous alkanol solution is at least about 95 percent by volume of 2-propanol and less than about 5 percent by volume of water, and wherein the amphiphilic is preferably an addition copolymer made from at least two comonomers selected from an alkyl methacrylate, N-vinyl pyrrolidone, N-vinyl pyridine, N-vinyl ε-caprolactam, methacrylic acid, acrylic acid, hydroxyethyl methacrylate, and vinyl acetate. Additionally, the film-forming composition includes but is not limited to at least one organic compound selected from: (a) acephate—Acetylphosphoramidothioic acid O,S-dimethyl ester; (b) bifenthrin—2-methylbiphenyl-3-lymethyl-(Z)-(1RS)-cis-3-(2-chloro-3,3,3-trifluoroprop-1-enyl)-2-2-dimethylcyclopropanecarboxylate; (c) carbaryl—1-naphthyl N-methylcarbamate; (d) chlorpyrifos—O,O-diethyl O-3,5,6-trichloro-2-pyridyl phosphorothioate; (e) cypermethrin—3-(2,2-Dichloroethenyl)-2,2-dimethylcyclopropanecarboxylic acid cyano(3-phenoxyphenyl)-methyl ester; (f) diflubenzuron—1-(4-chlorophenyl)-3-(2,6-difluorobenzoyl) urea (g) imidacloprid—1-[(6-Chloro-3-pyridinyl)methyl]-4,5-dihydro-N-nitro-1H-imidazol-2-amine; (h) lindane—Gamma benzene hexachloride; (i) malathion—[(Dimethoxyphosphino-thioyl)thio]butanedioic acid diethyl ester; (j) methoxychlor—1,1,1-trichloro-2,2-bis(p-methoxyphenyl)ethane; (k) permethrin—3-(2,2-Dichloroethenyl)-2,2-dimethylcyclopropane-carboxylic acid (3-phenoxyphenyl)methyl ester; (l) phosmet—O,O-dimethyl S-phthalimidomethyl phosphorothionate; and (m) trichlorfon—(2,2,2-Trichloro-1-hydroxyethyl)-phosphonic acid dimethyl ether.

From a technological perspective, this invention deals with a film-forming composition for the treatment of pests which is an alkanol or aqueous alkanol solution of at least one amphiphilic polymer and a pesticide wherein upon application the pesticide is released in a controlled manner, wherein the amphiphilic polymer is an addition copolymer made by the free-radical polymerization of N-vinyl-2-pyrrolidone, n-hexylmethacrylate, and n-butylmethacrylate in 2-propanol in the presence of a free-radical initiator, and wherein the amphiphilic polymer comprises from about 1 to about 15 percent by weight of the alkanol or aqueous alkanol solution. Additionally, from an application perspective, the specific pesticidal properties of the (a) alkanol or aqueous alkanol solution are achieved by incorporating acephate and wherein the acephate comprises from about 1 to about 10 percent by weight in the alkanol or aqueous alkanol solution for the treatment of fire ants and tent caterpillars—for treating the fire ants, the acephate-containing composition is applied by a method such as spraying the composition with a compression sprayer onto physically disturbed or undisturbed mounds, thereby forming an acephate-loaded amphiphilic film thereon, and for controlling caterpillar infestation, the acephate-containing composition is applied by a method such as spraying it using a compression sprayer onto a tree trunk in order to form a continuous band around the trunk near the tree base, wherein the band is an acephate-loaded amphiphilic film; (b) alkanol or aqueous alkanol solution comprises a 2-propanol solution containing 2 to 30 percent by volume of an aliphatic ketone selected from the group consisting of acetone, 2-butanone, and 3-pentanone, and wherein the composition comprises from about 0.1 to about 10 percent by weight/volume of at least one pesticide selected from the group consisting of but not limited to acephate, carbaryl, chlorpyrifos, bifenthrin, and cypermethrin for treating fire ants; (c) alkanol or aqueous alkanol solution comprises a 2-propanol solution containing 2 to 30 percent by volume of at least one aliphatic ketone selected from the group consisting of acetone, 2-butanone, and 3-pentanone and wherein the composition comprises from about 0.1 to about 10 percent by weight/volume of at least one pesticide selected from the group consisting of bifenthrin, carbaryl, chlorpyrifos, cypermethrin, imidacloprid, and permethrin for treating bark beetles; (d) alkanol or aqueous alkanol solution comprises a 2-propanol solution containing 2 to 30 percent by volume of acetone and wherein the composition comprises from about 0.1 to about 10 percent by weight/volume of chlorpyrifos for treating wood-boring beetles; (e) alkanol or aqueous alkanol solution comprises a 2-propanol solution containing 2 to 30 percent by volume of at least one aliphatic ketone selected from the group consisting of acetone, 2-butanone, and 3-pentanone and wherein the composition comprises from about 0.1 to about 10 percent by weight/volume of at least one pesticide selected from the group consisting of acephate, carbaryl, and diflubenzuron for treating gypsy moth; and (f) alkanol or aqueous alkanol solution comprises a 2-propanol solution containing 2 to 30 percent by volume of at least one aliphatic ketone selected from the group consisting of acetone, 2-butanone, and 3-petanone and wherein the composition comprises from about 0.1 to about 10 percent by weight/volume of at least one pesticide selected from the group consisting of acephate, carbaryl, methoxychlor, and malathion for treating tent caterpillars.

### DETAILED DESCRIPTION OF PREFERRED EMBODIMENTS

The present invention is directed to liquid pesticides and allied formulations that are suitable for application as a spray or paint that dries at the infested site to allow the controlled release of the desired agent for a predetermined period of time without being compromised by prevailing environmental factors. The components of the liquid formulation are selected to (1) be compatible with the application method, such as spraying or painting; (2) allow a timely formation of an amphiphilic pesticide-loaded film that adheres well to the different application sites infested with at least one damaging form of pest during at least one phase of the pest's life cycle; (3) form a pesticide-loaded film that is capable of releasing the agent at a fast rate shortly after contacting the site and maintaining a steady release for at least two days thereafter, by virtue of the composition of the film, which undergoes controlled dissolution upon exposure to water leading to a decrease in thickness and hence, compensating for the decrease in the net concentration of the agent in the film; and (4) provide a film that has a finite life that terminates shortly after releasing most, if not all, of its active agent—as the film continues to dissolve and becomes more water soluble, it peels off the site and creates a limited mass of partially degraded polymer that has minimum impact on the surrounding environment.

The design of the polymer molecular chain of the film material, subject of this invention, is based on (1) using at least two monomers to yield, simultaneously, hydrophilic repeat units that are randomly placed with hydrophobic repeat units or present as short- or long-segments in a segmented form, thus producing random or segmented chains that are amphiphilic—typical examples of the hydrophilic repeat precursors are hydroxyethyl methacrylate, acrylamide, methacrylic acid, N-vinyl pyridine, N-vinyl pyrrolidone, N-vinyl ε-caprolactam, while the precursor of the hydrophobic repeat units include methyl methacrylate, ethyl methacrylate, propyl methacrylate, n-butyl methacrylate, isobutyl methacrylate, n-hexyl methacrylate, octyl methacrylate, and styrene; (2) ensuring that part of the hydrophobic component has a glass transition temperature close to room temperature to impart film flexibility and mechanical compliance at different application sites—typical examples of the monomeric precursors of such chain sequence include n-hexyl and n-octyl methacrylate; (3) selecting at least one of the precursors of the hydrophobic sequence to be susceptible to ester hydrolysis, thus forming carboxylic groups to allow for increased solubility of the film and hence, its propensity to wash away from the application site following the release of its pesticide payload—a typical example of this monomeric precursor is an alkyl methacrylate; (4) using a combination of hydrophilic and hydrophobic comonomers having a comparable or substantially different reactivity ratio to permit the formation of random or segmented copolymers at will—typical combinations include N-vinyl pyrrolidone and one or more alkyl acrylate(s); (5) using combinations of comonomers having different reactivity ratios as well as controlling the monomer feed to allow intermittent formation of one or more type(s) of continuous sequence of repeat units—this is to produce amphiphilic chains having hydrophilic and/or hydrophobic segments; and (6) controlling the polymer chain composition and polarity to allow its solubility in a liquid solvent that is also a good solvent for most effective pesticides disclosed in this invention—a typical polymer-solvent combination is a copolymer containing about 20 weight percent of N-vinyl pyrrolidone-based repeat units and about 80 weight percent of a methacrylate-based sequence dissolved in 2-propanol mixed with less than about 3 percent water.

The selection of the solvent component of the formulation is based on (1) its ability to dissolve both the pesticide to yield the desired range of concentrations; (2) its ability to mix freely with water and to allow the presence of certain amounts of the water in the film immediately after formation, which, in turn, allows the film to remain swollen and release the initial fraction of the of agent at a fast rate, if so needed; having a boiling temperature and solubility to allow its timely evaporation during film formation without being highly susceptible to ignition; (4) being harmless to the environment about the infested site; and (5) being suitable to dispense through conventional equipment, such as a compression sprayer and trigger spray bottle. Typical examples of desirable solvents include one or mixed alkanol selected from the group represented by 2-propanol, t-butyl alcohol, ethanol, and n-butanol, with or without further mixing with an aliphatic ketone such as acetone, 2-butanone, and 3-pentanone.

The selection of the pesticide or combination thereof is based on (1) exhibiting no chemical reaction with the solvent or the polymer component of the formulation; (2) having a reasonable shelf-life in the liquid formulation; (3) having sufficient solubility in the solvent to allow achieving the needed concentration; (4) being stable in the alkanol or aqueous alkanol solvent; and (5) exhibiting a broad spectrum and effect on more than one pest during at least one phase of their life cycles. Typical examples of these pesticides that can be used individually or in combination (without interacting chemically) are: acephate, bifenthrin, carbaryl, chlorpyrifos, cypermethrin, diflubenzuron, imidacloprid, lindane, malathion, methoxychlor, permethrin, phosmet, and trichlorfon.

This invention also deals with methods of applying the pesticide-containing and other allied formulation, which entails using a compression sprayer, trigger spray bottle, spray pump, and brush as well as similar modifications thereof. For the fire ant mounds, the formulation is sprayed on the entire area and preferably 10 percent beyond the visible perimeter. It is also preferable that the mounds are mechanically disturbed prior to spraying. For treating the gypsy moth and tent caterpillar, a complete band of film is formed around the tree trunk about 30 cm from the ground. The width of the band should exceed 3 cm and preferably more than 15 cm. More than one band along the tree trunk is also preferred.

Further illustrations of the present invention are provided by the following examples:

### EXAMPLE 1

### Synthesis of a Typical Amphiphilic Polymer Using N-Vinyl Pyrrolidone (NVP), n-Butyl Methacrylate (BMA), and n-Hexyl Methacrylate (HMA)

A mixture of NVP (45.3 g-0.4075 mole), BMA (115.9 g-0.8150 mole) and HMA (138.8 g-0.8150 mole) was transferred to a predried 3-neck flask equipped for mechanical stirring, an inlet for introducing nitrogen, and a reflex condenser. The charge was sparged with nitrogen. An aliquot of an azo initiator, namely 2,2′-bis-isobutyronitrile (2.25 g-0.0137 mole) was added to the comonomers. To this was transferred an aliquot of 2-propanol (300 mL) and the charge was sparged with nitrogen. The reactor components were rearranged to proceed with the polymerization while stirring under a nitrogen atmosphere. The azo initiator dissolved and the reaction mixture was heated to 65° C. while stirring for about 24 hours, until practically all the monomers were polymerized. This was achieved through periodic analysis of the reaction mixture by gel permeation chromatography (GPC) to determine the extent of monomer conversion. After cooling to room temperature, an aliquot of the polymer solution in 2-propanol was withdrawn and heated at 40° C. under reduced pressure to yield a dry polymer which was used to (1) confirm its composition using IR, NMR spectroscopy, and elemental analysis for nitrogen; (2) determine its molecular weight using GPC; (3) determine its thermal properties in terms of thermal transitions using differential scanning calorimetry; and (4) assess the polymer film-forming quality by casing on Teflon paper and qualitatively assessing the film flexibility, affinity to water, and resistance to dissolve in water.

### EXAMPLE 2

### Preparation of a Typical Film-Forming Pesticidal Formulation Using the Reaction Product from Example 1 and Acephate

Prior to preparing the active formulation, about 1,000 mL of 2-propanol was transferred to the reaction product from Example 1, stirred to homogenize at 65° C., and cool to room temperature. An aliquot of this diluted polymer solution was mixed with an aliquot of acephate granules and a sufficient amount of 2-propanol as well as a small amount of water to yield a solution containing 3 percent weight/volume of acephate, 3 percent weight volume of the polymer, and about 2 percent by volume of water. The resulting formulation was evaluated qualitatively for ease of application using a trigger spray bottle or compression sprayer and film formation by casing on a Teflon sheet.

### EXAMPLE 3

### Application of the Acephate Controlled Release Film-Forming Solution from Example 2 to Fire Ant Mounds

The acephate solution from Example 2 was applied using a compression sprayer to the fire ant mounds using three protocols, namely, (a) through spraying undisturbed mounds, (b) spraying disturbed mounds, and (c) spraying undisturbed mound which then was disturbed and resprayed. All mounds were checked over a period of 5 days for fire ant vitality. All types of mounds were shown to be free of viable ants at 4 days post-treatment. However, the effectiveness of the treatment increased from protocol (a) to (c) with the protocol revealing no signs of vitality in less than 2 days.

### EXAMPLE 4

### Application of the Acephate Controlled Release Film-Forming Solution from Example 2 to a Tree Infested with Tent Caterpillars

Using a compression sprayer as described in Example 3, a 15 cm wide film was formed around the trunk of a cherry tree infested with tent caterpillar. The film was formed at the base of the trunk about 30 cm from the ground. The tree was monitored over a 2-week period and the film was shown to prevent the caterpillars from migrating from the tree base to areas of the trunk above the film location.

Although the present invention has been described in connection with the preferred embodiments, it is to be understood that modifications and variations may be utilized without departing from the principles and scope of the invention, as those skilled in the art will readily understand. Accordingly, such modifications may be practiced within the scope of the following claims. Moreover, Applicant hereby discloses all subranges of all ranges disclosed herein. These subranges are also useful in carrying out the present invention.

What is claimed is:

1. A film-forming composition for the treatment of pests comprising an alkanol solution of at least one amphiphilic polymer and a pesticide wherein upon application the pesticide is released in a controlled manner.

2. A film-forming composition as in claim 1 wherein the alkanol solution comprises at least about 95 percent by volume of 2-propanol and less than about 5 percent by volume of water.

3. A film forming composition as in claim 1 wherein the amphiphilic polymer comprises an addition copolymer made from at least two comonomers selected from the group consisting of an alkyl methacrylate, N-vinyl pyrrolidone, N-vinyl pyridine, N-vinyl ε-caprolactam, methacrylic acid, acrylic acid, hydroxyethyl methacrylate, and vinyl acetate.

4. A film-forming composition as in claim 1 wherein the pesticide composition comprises at least one organic compound selected from the group consisting of acephate, bifenthrin, carbaryl, chlorpyrifos, cypermethrin, diflubenzuron, imidacloprid, lindane, malathion, methoxychlor, permethrin, phosmet, and trichlorfon.

5. A film-forming composition as in claim 1 wherein the amphiphilic polymer comprises an addition copolymer made by the free-radical polymerization of N-vinyl-2-pyrrolidone, n-hexylmethacrylate, and n-butylmethacrylate in 2-propanol in the presence of a free-radical initiator.

6. A film-forming composition as in claim 5 wherein the amphiphilic polymer comprises from about 1 to about 15 percent by weight of the alkanol solution.

7. A film-forming composition as in claim 6 wherein the pesticide comprises acephate and wherein the acephate comprises from about 1 to about 10 percent by weight in the alkanol solution.

8. A film-forming composition as in claim 7 for the treatment of fire ants and tent caterpillars.

9. A film-forming composition as in claim 7 for treating fire ants and applied by a method comprising spraying the composition with a compression sprayer onto physically disturbed or undisturbed mounds, thereby forming an acephate-loaded amphiphilic film thereon.

10. A film-forming composition as in claim 7 for controlling caterpillar infestation and applied by a method comprising spraying the composition using a compression sprayer onto a tree trunk in order to form a continuous band around the trunk near the tree base, the band comprising an acephate-loaded amphiphilic film.

11. A film-forming composition as in claim 6 wherein the alkanol solution comprises a 2-propanol solution containing 2 to 30 percent by volume of an aliphatic ketone selected from the group consisting of acetone, 2-butanone, and 3-pentanone, and wherein the composition comprises from about 0.1 to about 10 percent by weight/volume of at least one pesticide selected from the group consisting of acephate, carbaryl, chlorpyrifos, bifenthrin, and cypermethrin for treating fire ants.

12. A film-forming composition as in claim 6 wherein the alkanol solution comprises a 2-propanol solution containing 2 to 30 percent by volume of at least one aliphatic ketone selected from the group consisting of acetone, 2-butanone, and 3-pentanone and wherein the composition comprises from about 0.1 to about 10 percent by weight/volume of at least one pesticide selected from the group consisting of bifenthrin, carbaryl, chlorpyrifos, cypermethrin, imidacloprid, and permethrin for treating bark beetles.

13. A film-forming composition as in claim 6 wherein the alkanol solution comprises a 2-propanol solution containing 2 to 30 percent by volume of acetone and wherein the composition comprises from about 0.1 to about 10 percent by weight/volume of chlorpyrifos for treating wood-boring beetles.

14. A film-forming composition as in claim 6 wherein the alkanol solution comprises a 2-propanol solution containing 2 to 30 percent by volume of at least one aliphatic ketone selected from the group consisting of acetone, 2-butanone, and 3-pentanone and wherein the composition comprises from about 0.1 to about 10 percent by weight/volume of at least one pesticide selected from the group consisting of acephate, carbaryl, and diflubenzuron for treating gypsy moth.

15. A film-forming composition as in claim 6 wherein the alkanol solution comprises a 2-propanol solution containing 2 to 30 percent by volume of at least one aliphatic ketone selected from the group consisting of acetone, 2-butanone, and 3-petanone and wherein the composition comprises from about 0.1 to about 10 percent by weight/volume of at least one pesticide selected from the group consisting of acephate, carbaryl, methoxychlor, and malathion for treating tent caterpillars.
